(19) United States
(12) Patent Application Publication
(10) Pub. No.: US 2011/0221153 A1
(43) Pub. Date: Sep. 15, 2011

(54) COUPLING BAR FOR A VEHICLE

(75) Inventors: Ulrich Bladt, Ibbenburen (DE); Olaf Beutler, Diepholz (DE); Günter Lohfink, Bad Harzburg (DE); Karl-Walter Palluck, Damme (DE); Stefan Loheide, Wallenhorst (DE); Dirk Lamla, Bramsche (DE); Stefan Schönhoff, Belm (DE); Christian Maassmann, Merzen (DE)

(73) Assignee: ZF FRIEDRICHSHAFEN AG, Friedrichshafen (DE)

(21) Appl. No.: 12/672,962

(22) PCT Filed: Jul. 30, 2008
(86) PCT No.: PCT/DE2008/050015

§ 371 Date: Mar. 2, 2010

(30) Foreign Application Priority Data
Aug. 14, 2007 (DE) 10 2007 038 494.9

(51) Int. Cl. B60G 21/055; F16C 11/06; B23P 11/00

(52) U.S. Cl. 280/124.106; 403/135; 29/898.12

(57) ABSTRACT

A linking rod for a vehicle comprising a basic body (2). The basic body (2) comprises a bearing housing (3) and a joint housing (4) which are spaced apart from one another by a coupling piece (9) of the basic body (2). The bearing housing (3), of the basic body (2). is formed from a first plastic material which is surrounded by an enclosure (7) which is made from a second plastic material that is softer than the first plastic material.

This application is a National Stage completion of PCT/DE2008/050015 filed Jul. 30, 2008 which claims priority from German patent application serial no. 10 2007 038 494.9 filed Aug. 14, 2007.

### FIELD OF INVENTION

The invention relates to a linking rod for a vehicle, with a basic body, a bearing housing which has a bearing, a joint housing formed by the basic body which has a certain spacing from the bearing housing, and a coupling piece, formed by the basic body, which extends between the bearing housing in the joint housing, and connects the two housings with each other. Furthermore, the invention relates to a vehicle having such a linking rod, as well as a method for manufacturing the linking rod.

### BACKGROUND OF THE INVENTION

DE 34 12 578 C1 relates to a suspension for vehicles comprising two kingpins for supporting a vehicle, at each their free ends, pivotable about a transversal axle, elastically supported training arms in correlation with the vehicle body, which are spaced from the vehicle bearings, connected, especially angularly rigid, by an elastically twistable, open profile crossbar. The crossbar is finished to a full body through a specifically light and resistance-free plastic material having a streamlined form and closed profile. To protect the soft elastic plastic material from external damage, an impact resistant waterproof cover, which can be a plastic skin, is therefore provided.

DE 35 35 783 C2 describes a rear suspension for vehicles in which spindles are positioned at the free ends of the trailing arms to the chassis, and the ends of the trailing arms are connected with the profile shaped crossbar, neither are the spindles. At one of the crossbar profile site is a protective part flexibly mounted, across their length and at least to their bottom edge, which has a tilted, outer circumferential area, which is tilted from near the bottom edge of the crossbar to the upside. An elastic part can be positioned between the protective part and the crossbar.

Known from DE 20 2005 004 964 U1 is a suspension for a vehicle axle, which has a rigid axle with at least one wishbone plate which is hinged, on both sides of the vertical longitudinal vehicle centerline, with its front end to a chassis bearing, and attached to the axle body, spaced from it. A support arm, extending from the axle body to the rear, forms the lower resting support for a spring, the chassis bracing itself on the top site, the at least one wishbone plate is equipped with a permanently elastic protective cover, at least in an area between its front end and the axle body mounting area. The protective cover, based on the plastic material, can completely, or almost completely, extend to an area between the bearing and the axle mounting, as well as completely surround the wishbone plate in the area in which it is supposed to be.

The linking rod, as previously mentioned in the state of the art, is applied in vehicles to link a sway stabilizer to a wheel suspension, and is hinged by means of a bearing to the sway stabilizer. Hereby, tests are performed to manufacture the basic body from a plastic material and to integrate the bearing housing in it. If, however, the bearing housing is formed by the basic body, and is manufactured completely from plastic, there is a danger that rocks could damage the bearing housing, where by the linking rod would become unusable.

### SUMMARY OF THE INVENTION

Hereby, it is the task of this invention to advance the design of a linking rod, as previously mentioned in the state of the art, so that such damages of the bearing enclosure are avoided, or at least reduced.

The inventive linking rod for a vehicle, particularly a motor vehicle, comprises a basic body, including a bearing and bearing enclosure, a joint housing formed by the basic body, spaced from the bearing housing, and a coupling piece, formed by the basic body, which extends between the bearing housing and the joint housing, and connects the two housings, whereby the joint housing is formed by the basic body, made out of the first plastic material, which is surrounded by a casing comprising a second plastic material, which is softer than the first plastic material.

The casing is, therefore, softer then the basic body and forms a soft part, which is very resistant against rocks and mechanical abrasion, due to a high ability for energy absorption, and it also offers an acoustic advantage. Another advantage can be seen by comparing concepts which provide a separate shielding, by achieving a reduction in weight as well as an integrated solution. The term ‘softer’ needs to be especially understood, in a way that the first plastic material, and therefore the basic body, demonstrates a greater mechanical stiffness, then the second plastic material, therefore it is higher than the casing.

The entire basic body can be covered by the casing. However, it is preferred to have an adjacent area of the coupling piece, annexed to the bearing housing, to be covered by the casing. The casing can hereby completely cover the area of the coupling piece. In addition, the casing can cover completely the bearing housing, whereby preferably areas, in which an inner part of the bearing (bearing inner part) extends out from the bearing enclosure, are excluded. The casing, in particular, represents a one-piece plastic part. Also, the joint housing can be completely covered by the casing whereby, and preferably, an area is exempt in which a joint inner part extends out from the joint enclosure.

The two plastic materials preferably comprise different technical plastics. The first plastic material comprises, for instance, polyamide (PA), polypthalamide (PPA), polyphenylensulfide (PPS), polyetherimide (PEI), polyetheretherketone (PEEK) or some other technical plastic. Also, the first plastic material can be reinforced with fiber and/or with mineral particles. Preferably, the first plastic material is a glass fiber reinforced polyamide such as, for instance, PA6, GFX or PA 6.6 GF 30.

The second plastic material comprises, for instance, polyurethane (PUR) or another technical plastic, for instance, an elastomer or a thermo plastic elastomer (TPE). Particularly, the second plastic material is not reinforced with fiber.

The bearing is preferably designed as an elastomeric bearing and has a sleeve as well as an elastomeric body, surrounding or wrapped around the sleeve, which is positioned between the sleeve and the bearing enclosure, whereby the sleeve is made from metal. Preferably, the elastomeric body is firmly connected to the sleeve. In addition, the elastomeric body can be firmly connected to the bearing housing. Preferably, the elastomeric housing is a rubber bearing, and the elastomeric body is a rubber body. The sleeve forms the bearing inner part, especially in combination with the elastomeric body, which preferably extends out from the bearing housing on both sides.

The joint housing preferably has a joint inner part like, for instance, a joint staff flexibly mounted which forms a joint together with the joint housing. The mounting of the joint inner part in the joint housing takes place through interconnecting a bearing socket, which is preferably positioned in the bearing housing or is integrated into it and/or is formed by the basic body. The inner part of the joint is particularly a ball stud which has a joint ball through which it is rotatable and/or swayable in the ball socket. The bearing socket is preferably a ball socket.

The bearing housing is particularly positioned at a first end of the basic body, and the joint housing is particularly positioned at the second end of the basic body.

Preferably, the bearing housing, the joint housing and the coupling piece form a one-piece plastic part which particularly forms the basic body. The joint socket is especially also a part of this one-piece plastic part.

The coupling piece has a ribbed H-profile. Alternatively, the coupling piece can also have other, adequate profiles.

In addition, the invention relates to a vehicle, especially a motor vehicle with a chassis, at least a steering knuckle, at least a vehicle wheel rotatably mounted to the steering knuckle, at least one suspension arm through which the steering knuckle is flexibly mounted to the vehicle body, and at least a sway stabilizer mounted to the vehicle chassis which, by means of the linking rod, is hinged together with the steering knuckle or with the suspension arm. The linking rod is the invented linking rod which can, in accordance with all a mentioned embodiments, be expanded and upgraded. Particularly, a joint stud is flexibly positioned in the joint housing to create a joint whereby the linking rod, preferably by means of the bearing, is hinged to the sway stabilizer, and by means of the joint, hinged to the steering knuckle or two suspension arms. The joint stud is preferably a ball stud.

The suspension arm is preferably a trailing arm, but can also be a transversal part along or another suspension arm.

In addition, the invention relates to a method for manufacturing a linking rod, whereby an assembly, comprising a sleeve, an elastomeric body which surrounds the sleeve, is overmolded with a first plastic material, to form a joint housing, and here for, a distanced, the assembly surrounding joint housing, whereby later at least the bearing housing is overmolded with a second plastic material, forming a cover which is softer than the first plastic material. Through the invented method, the particular invented linking rod is produced. In addition, the term “softer” has to be understood in a way that the first plastic material possesses a greater mechanical stiffness than the second plastic material.

Preferred, when overmolding the assembly with the first plastic material, a ball socket, which is surrounded by the joint housing and/or is integrated into it, is create at the same time. Thereafter, a ball stud can be inserted into the ball socket so that a ball joint is formed.

The manufacturing of the linking rod particularly takes place through a conversion method. Hereby, the assembly is inserted into a first tool and is overmolded with the first plastic material. Thereafter, the basic body is removed from the first tool, inserted into a second tool and here in overmolded with the second plastic material. Alternatively, also other methods can be applied for manufacturing the linking rod, For instance, the application of a two-component method (2-K method) in a rotation principle is possible.

### BRIEF DESCRIPTION OF THE DRAWINGS

In the following, based on a preferred embodiment, the invention is described through the drawings. The drawings show:

FIG. 1: a side view of a linking rod in accordance with an embodiment of the invention,

FIG. 2: a sectional view through the bearing of the linking rod as in FIG. 1,

FIG. 3: a sectional view through the linking rod in accordance with the sectional line A-A of FIG. 1, and

FIG. 4: a schematic of a wheel suspension of a motor vehicle having the linking rod as in FIG. 1.

### DETAILED DESCRIPTION OF THE PREFERRED EMBODIMENTS

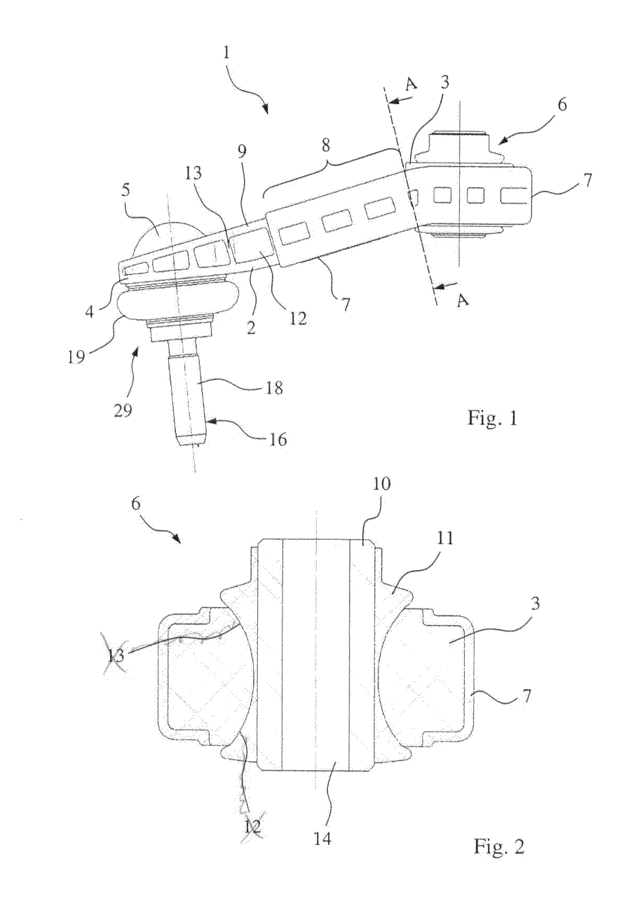

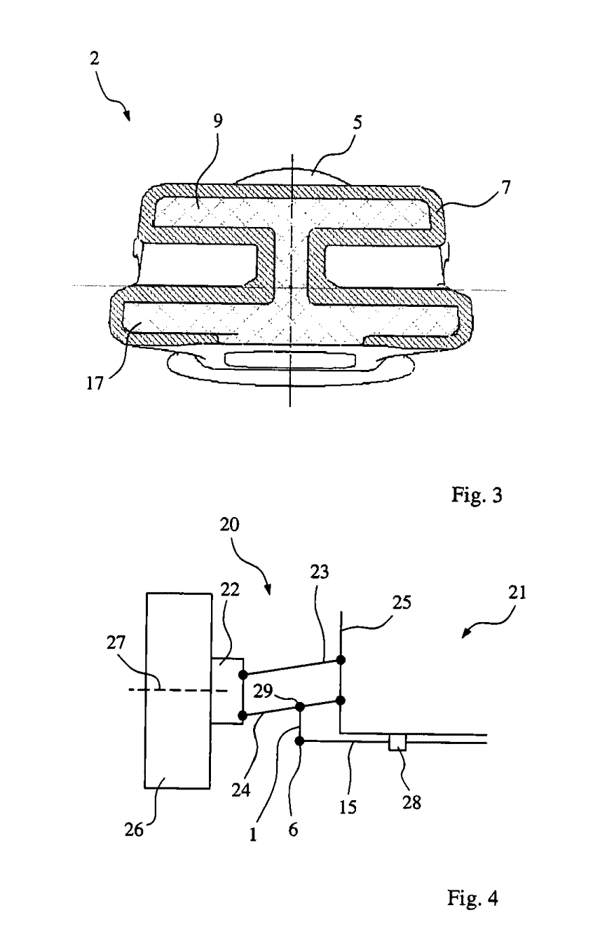

In FIG. 1, a side view of a linking rod 1, in accordance with the invention, is shown whereby a basic body 2, manufactured from a first plastic material, has an elastomeric bearing housing 3, a ball joint housing 4, a ball socket 5, positioned either in or integrated with the ball joint housing 4, as well as a coupling piece 9, which extends between the elastomeric bearing housing 3 and the ball joint housing 4 and connects the two housings 3 and 4 with one another. Hereby, the coupling piece 9 has a ribbed H-profile part 17 (see FIG. 3) with cut outs 12 and ribs 13. The elastomeric bearing housing 3, the ball joint housing 4, the ball socket 5 and the coupling piece 9 together form a one-piece plastic part which forms the basic body 2. The elastomeric bearing housing 3 is a part of an elastomeric bearing 6 and surrounded by an enclosure 7 which, in addition, covers an enclosed area 8 of the coupling piece 9. The enclosure 7 comprises of a second plastic material which has a lesser stiffness or hardness, respectively, then the first plastic material.

A ball stud 16 is rotatable and pivotally embedded into the ball socket 5 so that a ball joint 29 is formed by the ball joint housing 4, the ball socket 5 and the ball stud 16. The ball stud 16 has a stud 18 which extends with it out of the ball joint housing 4 and is attached to a sealing bellow 19, which extends between the ball joint housing 4 and the stud 18, and forms a tight seal.

A sectional view of the elastomeric bearing 6 is shown in FIG. 2, whereby a cylindrical metal sleeve 10 is surrounded by an elastomeric body 11 and is firmly linked with it. The sleeve 10 and the elastomeric body 11 form a bearing inner part or an assembly, which extends through and to the outside of the elastomeric bearing housing 3 on both sides. In addition, the sleeve 10 is equipped with a through-hole, into which a bolt can be inserted to tighten the elastomeric bearing 6 to a sway stabilizer 15 (see FIG. 4). The enclosure 7 form-lockingly surrounds the elastomeric bearing housing 3 and altogether form a one-piece plastic body.

A sectional view through the basic body 2, along the shown section line A-A can be seen from FIG. 3, whereby the ball stud 16 and the sealing bellow 19 are not shown. The H-profile 17 of the coupling piece 9, which is surrounded by the enclosure 7 which follows the shape of the H-profile 17, is clearly visible.

A schematic presentation of a wheel suspension 20, of a partially presented motor vehicle 21, can be seen from FIG. 4 whereby a steering knuckle 22 is hinged to a vehicle body 25 by an upper suspension arm 23 and a lower suspension arm 24. A vehicle wheel is pivoted to the steering knuckle 22 whereby one end of the stabilizer 15 is hinged, by means of the elastomeric bearing 6, to the stabilizer 15, and hinged, by means of the ball joint 29, to the lower suspension arm 24.

### Reference Character Listing

1 Linking Rod

2 Basic Body

3 Elastomeric Bearing Enclosure

4 Ball Joint

5 Ball Socket

6 Elastomeric Bearing

7 Enclosure

8 Enclosed Area of the Coupling Piece

9 Coupling Piece

10 Sleeve

11 Elastomeric Body

12 Cut Out in the Coupling Piece

13 Rib of the Coupling Piece

14 Hole in Sleeve

15 Sway Stabilizer

16 Ball Stud

17 H-Profile Part

18 Stud

19 Sealing Bellow

20 Wheel Suspension

21 Motor Vehicle

22 Steering Knuckle

23 Upper Suspension Arm

24 Lower suspension Arm

25 Vehicle Body

26 Vehicle Wheel

27 Wheel Axle

28 Bearing for Stabilizer

29 Ball Joint

1-12. (canceled)

13. A linking rod for a vehicle with a basic body (2), a bearing (6) having a bearing housing (3), a ball joint housing (4) being spaced from the bearing housing (3) and formed by the basic body (2), a coupling piece (9), formed by the basic body (2), extending between the bearing housing (3) and the ball joint housing (4) for connecting the two housings (3, 4) with one another,
wherein the bearing housing (3) of the basic body (2) is formed from a first plastic material and is surrounded by an enclosure (7) which is formed from a second plastic material which is softer than the first plastic material.

14. The linking rod for the vehicle according to claim 13, wherein at least an area (8) of the coupling piece (9), adjacent the bearing housing (3), is surrounded by the enclosure (7).

15. The linking rod for the vehicle according to claim 13, wherein the first and the second plastic materials comprise different technical plastic material.

16. The linking rod for the vehicle according to claim 13, wherein the bearing (6) comprises a sleeve (10) and an elastomeric body (11) surrounding the sleeve (10), and the elastomeric body (11) is located between the sleeve (10) and the bearing housing (3).

17. The linking rod for the vehicle according to claim 13, wherein the coupling piece (9) has a ribbed H-profile (17).

18. The linking rod for the vehicle according to claim 13, wherein ball socket (5) is one of positioned in and integrated with the ball joint housing (4), formed by the basic body (2), and a ball stud (16) is flexibly pivoted to the ball socket (5).

19. The linking rod for the vehicle according to claim 13, wherein the bearing housing (3) is positioned at a first end of the basic body (2) and the joint housing (4) is positioned at an opposite second end of that basic body (2).

20. A vehicle having:
a vehicle body (25),
a vehicle wheel (26),
at least one steering knuckle (22) pivotably coupled to the vehicle wheel (26),
at least one lower suspension arm (24) via which the steering knuckle (22) is pivoted to the vehicle body (25),
at least one pivoting sway stabilizer (15) being supported by the vehicle body (25),
a linking rod comprising a basic body (2), a bearing (6) having a bearing housing (3), a bail joint housing (4) being spaced from the bearing housing (3) and formed by the basic body (2), a coupling piece (9), formed by the basic body (2), extending between the bearing housing (3) and the ball joint housing (4) for connecting the two housings (3, 4) with one another, and the bearing housing (3) of the basic body (2) is formed from a first plastic material and is surrounded by an enclosure (7) which is formed from a second plastic material which is softer than the first plastic material,
wherein the sway stabilizer (15) is hinged connected, via the linking rod (1), to at least one of the steering knuckle (22) and the lower suspension arm (24).

21. The vehicle according to claim 20, wherein a ball stud (16) is flexible mounted in the ball joint housing (4) to form a ball joint (29) whereby the linking rod (1) is, via the bearing (6), hinged to the sway stabilizer (15), and, via the ball joint (29), to one of the steering knuckle (22) and the lower suspension arm (24).

22. A method of manufacturing a linking rod, whereby an assembly comprising a basic body (2), an elastomeric body (11) surrounding a sleeve (10) and overmolded with a first plastic material, to form a bearing housing (3) which is spaced from a joint housing (4), the method comprising the step of:
at least forming the bearing housing (3) by overmolding an enclosure (7) which is a second plastic material that is softer than the first plastic material.

23. The method according to claim 22, further comprising the step of forming a ball socket (5), which is surrounded by the joint housing (4), at the same time during overmolding of the assembly with the first plastic material.

24. The method according to claim 22, further comprising the step of inserting a ball stud (16) into the ball socket (5).
